(19) United States
(12) Patent Application Publication
(10) Pub. No.: US 2014/0254602 A1
(43) Pub. Date: Sep. 11, 2014

(54) High Speed Network Contactless Rotary Joint

(71) Applicant: SCHLEIFRING UND APPARATEBAU GMBH, Furstenfeldbruck (DE)

(72) Inventor: Stephen Lindorfer, Munchen (DE)

(73) Assignee: SCHLEIFRING UND APPARATEBAU GMBH, Fürstenfeldbruck (DE)

(21) Appl. No.: 13/785,197

(22) Filed: Mar. 5, 2013

(51) Int. Cl. H04B 5/00

(52) U.S. Cl. CPC H04B 5/0012
USPC 370/401

(57) ABSTRACT

A contactless data link for connecting a first high speed network to a second high speed network that is rotatable relative to the first high speed network. The links includes a first data processor connected to the first network, and a second data processor connected to the second network. The link also includes a plurality of capacitive data links connected between the first data processor and the second data processor. Each capacitive data link comprises a transmitter amplifier, a capacitive coupler, and at least one receiver amplifier. For communication with the networks, each data processor comprises a physical layer network interface connected to one of the networks. An encoder may be provided for encoding the networks signals into signals, which may be transferred over the contactless data links, while a decoder may be provided for decoding the signals from the networks into signals for the network.

### TECHNICAL FIELD

The present invention relates to capacitive couplers for non-contacting or contactless signal and data transmission systems and method and, in particular, to capacitive rotating transmission devices. Such transmission devices may be used in computer tomography (CT) scanners.

### BACKGROUND

In CT scanners, a rotating x-ray tube and an x-ray detector generate high-speed imaging data. These may be transmitted from the rotating part to the stationary part of the tube. Furthermore, control signals for controlling the device and specifically the power supply of the x-ray tube may be transmitted from the stationary to the rotating part. Many applications exist where there is the need to transmit control signals between a rotor and a stator like in wind mills, revolving transfer machines, bottling plants, packaging machines or placement heads of insertion machines.

A contactless data link is disclosed in U.S. Pat. No. 6,956,450 B1. Here, binary data is fed into a transmission line at the rotating part. The transmission line has a low pass filter characteristic to suppress high frequency noise. It is terminated at its ends with the characteristic impedance of the line. Furthermore, it is split into two segments of equal length, each spanning half the circumference of a rotating structure. This transmission system cannot transfer signals, as they are required by the physical layer specification of standard communication networks such as Ethernet.

### SUMMARY

The embodiments of the invention are directed to a capacitive transmission system suitable for transmitting data of high-speed communication networks such as Ethernet, for example. The solution should be simple, inexpensive, modular, and easy to manufacture.

In an embodiment, a capacitive data link has a first part rotatable with respect to a second part. The first part may be rotating, while the second part is stationary, or the first part may be stationary while the second part is rotating. There is at least one contactless, capacitive data link between the first and the second part. Preferably, a contactless data link comprises at least one transmitter amplifier, feeding a transmitting element. Preferably, the transmitting element comprises a transmission line, which may be a strip line or any other kind of line, such as a low pass filter line, for example. The transmission line preferably has a circular shape and includes a termination section, where the transmission line is interrupted and the open ends are terminated preferably by a termination resistor. Preferably, the line is fed by the transmitter amplifier at a location opposite to the termination section, thereby dividing the transmission line into two sub-sections having almost the same length.

At the second part, there is a receiving coupler, which preferably is disposed in close proximity to the transmission line. It is configured to pick up electrical signals from the transmission line. These signals are amplified by a receiver amplifier, which is also part of the data link. Furthermore, there may be, optionally, included an encoder before the transmitter amplifier, as well as a decoder after the receiver amplifier adapted to encode signals according to a specifically defined coding scheme.

In a further embodiment, there is a plurality of data links combined in operable cooperation with at least one data processor. Preferably, there is one data processor at the first side and another data processor at the second side of the embodiment. It is preferred that each data processor have a physical layer adaptor configured to interface with a specific high speed network such as Ethernet, which may be implemented according to at least one of the following standards: 100BaseTx, 1000Base-T, and 10GBase-T. Generally, the term network used herein is also applicable to denote bus systems or high-speed bus systems. The physical layer interface may have an output to deliver signals to the transmitter amplifier and an input for receiving signals from the receiver amplifier. The output may further be connected to the encoder to encode the signals adapted to the specific need of the data link. There may further be at least one demultiplexer for dividing the signal into a plurality of sub-signals, which may be transmitted in parallel over a plurality of capacitive data links. In order to adapt to the specific physical layer, the data processor may be enabled to change the type of modulation, encoding, protocol and channel coding related to communication between the network and the contactless link.

In addition to this transmitting section, the data processor may have a receiving section adapted to receive signals from a contactless data link. The receiving section preferably has a multiplexer to multiplex a plurality of signals from a plurality of contactless data links into a single signal. There may furthermore be a decoder for decoding the previously encoded signal. The decoded signals are fed into the input of the physical layer interface. Generally, the encoder and the decoder may include devices structured to change, in operation, the coding, which may be a combination of decoder and encoder. Therefore, the first encoder in the transmitting section may also comprise a decoder for decoding the signals from the network (the signals being encoded into signals suitable for the contactless data link after decoding), which preferably are binary signals. Furthermore, the decoder in the receiving section may also comprise an encoder to encode the decoded signals into a format suitable for the high-speed network. In a preferred embodiment, the data processor, at least one receiver, and at least one transmitter and their corresponding transmit and receive antennae are cooperated to define one mechanical unit, e.g. as components located on a single printed circuit board. With the electronic components mounted to one side of a printed circuit board, the opposite side is used to hold the transmission line as transmission coupler and a receiving coupler. With two boards facing each other with their couplers mechanically configured that a transmission line forming a ring is opposite to a receiving coupler even during rotation, a contactless link can be formed out of two printed circuit board.

### BRIEF DESCRIPTION OF THE DRAWINGS

In the following, the invention will be described, without limitation of the general inventive concept, in reference to examples of embodiments and in reference to the drawings, of which:

FIG. 1 shows an embodiment of the High Speed Network Contactless Rotary Joint (HSNCJ) according to the invention.

FIG. 2 shows a second embodiment of the NSNCJ.

FIG. 3 shows an illustration of a general CT scanner.

While the invention can be modified without changing the scope of the invention, it is understood that the drawings and detailed description below are not intended to limit the invention to the particular form disclosed. To the contrary, the intention is to cover all modifications, equivalents and alternatives falling within the spirit and scope of the present invention as defined by the appended claims.

### DETAILED DESCRIPTION

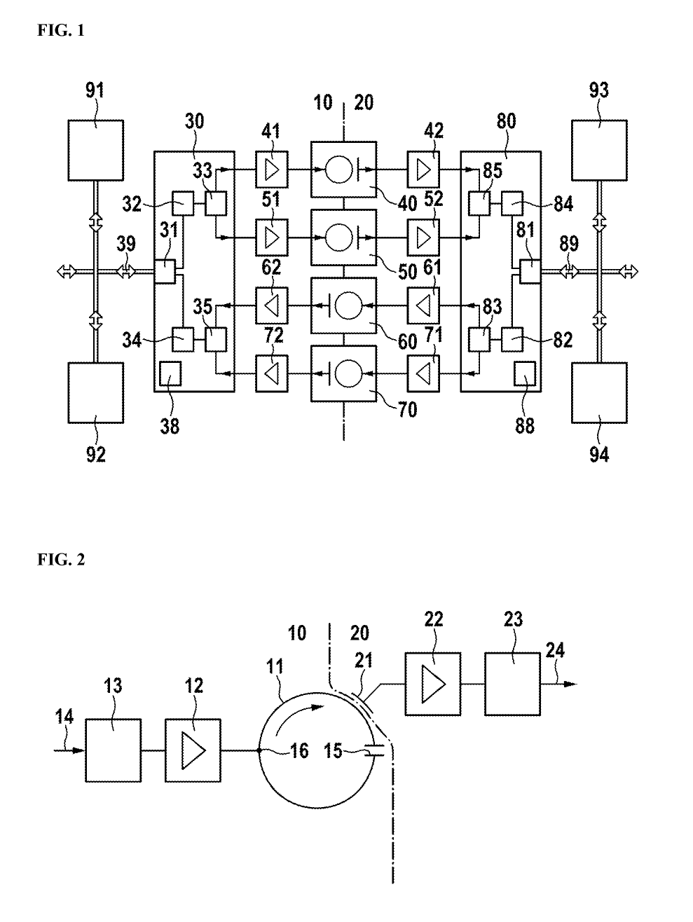

FIG. 1 shows a first embodiment of the invention. It has a first part 10, which may be the rotating part, and a second part 20, which may be the stationary part (or vice versa). Between the first part 10 and the second part 20, there are four contactless data links among which are four capacitive couplers 40, 50, 60, 70, which are fed by four transmitter amplifiers 41, 51, 61, 71, further forwarding the transmitted signals to four receiver amplifiers 42, 52, 62, 72. The data links based on the capacitive couplers 40 and 50 may transmit data from the first part 10 to the second part 20, while the data links based on the capacitive couplers 60 and 70 may transmit data from the second part 20 to the first part 10. Within the scope of the invention, the capacitive data links can be modified in total number as well as and in relationship to each direction required to specific needs. Accordingly, there may be only a single capacitive data link or a high number of such links. The first part 10 has a first data processor 30, while the second part 20 has a second data processor 80. In this embodiment, both data processors have a similar design. Each of the data processors has a transmission section, which is receiving signals from a high-speed network physical layer interface 31, 81, connected to an encoder 32, 82, further supplying encoded signals to a demultiplexer 33, 83, which splits the signal into two parallel signals for simultaneous transmission. The physical layer interfaces 31, 81 may interface to a plurality of network lines. At the receiving side, there is a multiplexer 35, 85 receiving signals from receiving amplifiers and generating a signal data stream which is further decoded by decoder 34, 84, and fed into the physical layer interfaces 31, 81. The data processors are controlled by control units 38, 88. The first data processor may be connected by a first network 39 to a first network node 91, a second network node 92, and further network nodes of the first network. The second data processor 80 may be connected by a second network 89 to a first network node 93, a second network node 94, and further network nodes of the second network.

FIG. 2 shows a related embodiment of the invention. The capacitive data link comprises a transmission line 11, which has a termination section 15, and a feeding point 16 preferably opposite to the termination section. Data signals to be transmitted are fed into the feeding point by a transmitter amplifier 12, which may receive signals from an encoder 13, which are delivered by a data input 14. At the receiving side, there is a receiving coupler 21, moving in close proximity to the transmitting line, capacitively picking up signals from the transmitting line and feeding the signals to a receiver amplifier 22, which are further forwarded to a decoder 23, having a data output 24.

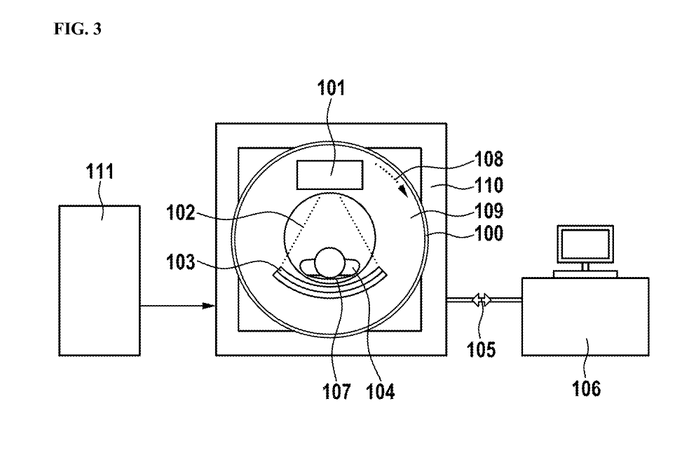

FIG. 3 shows schematically a CT scanner gantry. The stationary part of the gantry is suspended within a massive frame 110. The rotating part 109 of the gantry is rotatably mounted with respect to the stationary part and rotates in the rotation direction 108. The rotating part 109 supports an X-ray tube 101 enabled to generate an X-ray beam 102 that radiates, when switched on, through a patient 104 lying on a table 107 and is intercepted by a detector 103 and converted to electrical signals and imaging data thereof Electrical power from the power supply unit 111 may be transmitted by a slipring (not shown) to the rotating part 109. The data obtained by the detector 103 are transmitted via high-speed network contactless rotary joint 100 to an evaluation unit 106 by means of a data bus or network 105. While the application of an embodiment of the invention is described in reference to a CT scanner, it is intended that it is not limited to CT scanners.

It will be appreciated to those skilled in the art having the benefit of this disclosure that this invention provides capacitive rotary joints. Further modifications and alternative embodiments of various aspects of the invention will be apparent to those skilled in the art in view of this description. Accordingly, this description is to be construed as illustrative only and is for the purpose of teaching those skilled in the art the general manner of carrying out the invention. It is to be understood that the forms of the invention shown and described herein are to be taken as the presently preferred embodiments. Elements and materials may be substituted for those illustrated and described herein, parts and processes may be reversed, and certain features of the invention may be utilized independently, all as would be apparent to one skilled in the art after having the benefit of this description of the invention. Changes may be made in the elements described herein without departing from the spirit and scope of the invention as described in the following claims.

### LIST OF REFERENCE NUMERALS

10 first part
11 transmission line
12 transmitter amplifier
13 encoder
14 data input
15 termination section
16 feeding point
20 second part
21 receiving coupler
22 receiver amplifier
23 decoder
24 data output
30 first data processor
31 first physical interface (PHY)
32 first encoder
33 first demultiplexer
34 first decoder
35 first multiplexer
38 first control unit
39 first network
40 first capacitive coupler
41 first transmitter amplifier
42 first receiver amplifier
50 second capacitive coupler
51 second transmitter amplifier
52 second receiver amplifier
60 third capacitive coupler
61 third transmitter amplifier
62 third receiver amplifier
70 fourth capacitive coupler
71 fourth transmitter amplifier
72 fourth receiver amplifier
80 second data processor
81 second physical interface (PHY)
82 second encoder
83 second demultiplexer
84 second decoder
85 second multiplexer
88 second control unit
89 second network
91 first network node of first network
92 second network node of first network
93 first network node of second network
94 second network node of second network
100 contactless rotary joint
101 x-ray tube
102 x-ray beam
103 x-ray detector
104 patient
105 network
106 evaluation unit
107 patient table
108 rotation direction
109 rotating part
110 frame

1. A contactless data link for connecting a first high speed network (HSN) to a second HSN, the second HSN being rotatable relative to the first HSN, the contactless data link comprising
a first data processor connected to the first HSN and a second data processor connected to the second HSN; and
a plurality of capacitive data links, establishing operable communication between the first data processor and the second data processor, each capacitive data link comprising at least one transmitter amplifier, at least one capacitive coupler, and at least one receiver amplifier,
wherein each of the first and second data processors includes a physical layer network interface connected to at least one of the first HSN and the second HSN, and further comprising
at least one encoder adapted to encode signals from at least one of the first and second HSN into signals that are transferrable over the contactless data links, and
at least one decoder adapted to decode signals from the capacitive data links into signals acceptable by at least one of the first and second HSN.

2. A contactless data link according to claim 1, wherein at least one of the first data processor and second data processor comprises at least one demultiplexer structured to demultiplex signals of the at least one of the first and second HSNs into a plurality of signals for a plurality of contactless data links.

3. A contactless data link according to claim 1, wherein at least one of the first data processor and second data processor comprises at least one multiplexer enabled to multiple a plurality of signals received by contactless data links into a signal suitable for the at least one of the first and second HSNs.

4. A contactless data link according to claim 1, wherein at least one of the at least one transmitter amplifier, the at least one capacitive coupler, and the at least one receiver amplifier is located on a single printed circuit board.

5. A contactless data link according to claim 4, wherein at least one data processor is located on the single printed circuit board.

6. A contactless data link according to claim 1, wherein at least one of the at least one transmitter amplifier, the at least one capacitive coupler, and the at least one receiver amplifier is located on a single printed circuit board, and further comprising
a transmission line configured to operate as a transmission coupler and a receiving coupler on the opposite side of the printed circuit board with respect to the at least one transmitter amplifier and the at least one receiver amplifier (42, 52, 62, 72), the transmission line and the receiving coupler each including a copper structure.

7. A contactless data link according to claim 1, wherein the at least one of the first and second data processors (30, 80) is located on a single printed circuit board, and further comprising
a transmission line configured to operate as transmission coupler and a receiving coupler, said transmission line and receiving coupler disposed on a side of the single printed board that is opposite to the at least one of the first and second data processors, said transmission line and receiving coupler each including a copper structure.
